(19) United States
(12) Patent Application Publication
(10) Pub. No.: US 2015/0104781 A1
(43) Pub. Date: Apr. 16, 2015

(54) ORGAN STORAGE SOLUTION

(71) Applicant: bitop AG, Witten (DE)

(72) Inventors: Andreas Bilstein, Bergheim (DE); Georg Lentzen, Herdecke (DE); Rene Tolba, Aachen (DE); Fabian Bernal Quesnel, Barcelona (ES)

(73) Assignee: bitop AG, Witten (DE)

(21) Appl. No.: 14/385,391

(22) PCT Filed: Mar. 15, 2013
(86) PCT No.: PCT/EP2013/055378

§ 371 Date: Nov. 20, 2014

(30) Foreign Application Priority Data
Mar. 16, 2012 (DE) 102012005177

(51) Int. Cl. A01N 1/02

(52) U.S. Cl. CPC A01N 1/0226
USPC 435/1.1

(57) ABSTRACT

The invention relates to a storage solution for the preservation of organs, tissue or organ systems to be transplanted, said solution being based on the known HTK, UW or Celsior solutions. In accordance with the invention it has been determined that ischemia and reperfusion injury could be reduced through the addition of ectoine or hydroxyectoine.

The invention relates to a storage solution for the preservation of transplantation organs, tissue or organ systems.

The transplantation of organs, in particular kidney, heart, liver, pancreas and lung, plays a significant role in modern medicine. The transplantation of an organ may, for example, be necessary in case of chronic renal failure, certain coronary heart diseases, or cirrhosis of the liver. The majority of transplantations is performed using organs of brain-dead donors so that after organ removal has taken place a certain time will elapse during which a suitable recipient needs to be found and prepared which makes a preservation of the respective organ necessary. Therefore, the organ remains cut off from the oxygen supply for a certain time span, i.e. it passes through an ischemic phase associated with a relevant reversible injury. Typically, the organ is preserved or transported at a temperature as low as approx. 4° C. As regards ischemia a differentiation is made between the so-called warm ischemia time, which is the time span that elapses when blood perfusion in the donor body is interrupted and cold perfusion begins, and the cold ischemia time, i.e. when cold perfusion begins and the organ is implanted into the body of the recipient. In the event chilled storage in suitable organ preservation solutions is adopted the cold ischemia time in case of a kidney transplant may be extended up to 48 hours.

When an organ is removed, it is typically flushed through with the help of a perfusion solution and preserved in this fluid. A solution frequently put to use is the so-called UW solution (University of Wisconsin) the ion concentration of which corresponds to the concentration within the cells. Another organ storage solution which is often employed is the HTK solution inter alia put on the market by Dr. Franz Köhler Chemie GmbH, Bensheim, Germany under the tradename of Custodiol. The abbreviation HTK stands for the solution constituents histidine, tryptophan, and α-ketoglutarate. Moreover, another well-known organ preservation solution is distributed under the tradename of Celsior by Genzyme, Cambridge, USA.

Attempts have been made in recent times to make improvements aimed at minimizing injury to the organs to be transplanted. Aside from injuries/damage caused by ischemia itself the prevention of so-called reperfusion damage has been of major concern, with injury of this nature being encountered when the hypothermic organ is warmed up and reperfused with blood. For this reason the European patent EP 1 362 511 B1 proposes that a hydroxamic acid derivative be added to the organ storage solution. In patent EP 1 859 679 B1 it has been proposed to use a buffer on the basis of N-acetylhistidine/base.

Proceeding from the prior-art status described hereinbefore it is thus the objective of this invention to further minimize ischemia and reperfusion damage occurring during transplantation of organs, tissue, and organ systems.

In accordance with the invention this objective is reached by providing a storage solution as described in claim 1.

Surprisingly, it has been found in this context that damage to organs, tissue, and organ systems preserved in and perfused with the storage solution could be reduced if ectoine (2-methyl-1,4,5,6-tetrahydropyrimidine-4-carboxylic acid) or hydroxyectoine (5-hydroxy-2-methyl-1,4,5,6-tetrahydropyrimidine-4-carboxylic acid) respectively a salt, ester, or amide of these compounds was added to the storage solution. Ectoine is a tetrahydropyrimidine derivative which is synthetized under stress conditions in extremophilic, in particular halophilic microorganisms. Hitherto, various applications or uses have been described for ectoine and hydroxyectoine, for example as moisturizers, for the treatment of the vascular leak syndrome (VLS) (DE 10 2006 056 766 A1) or for the treatment of neurodermatitis (DE 103 30 243 A1). Moreover, the international patent application WO 2009/095269 A1 has also disclosed their use in the context of prevention or treatment of post-operative inflammatory stresses. It has also been proposed in that publication that the inflammatory reactions which are encountered during transplantation of intestinal segments could be lessened through the application of ectoine; however, the addition of ectoine or hydroxyectoine to an HTK, UW or Celsior solution has not been described therein. For those skilled in the art it thus came as a surprise to learn that the properties of these commercially available and proven organ storage solutions could be further improved through the addition of ectoine/hydroxyectoine. The solutions are as a rule provided in the form of aqueous solutions.

The structure of natural L-ectoine ((S)-2-methyl-1,4,5,6-tetrahydropyrimidine-4-carboxylic acid) is illustrated below:

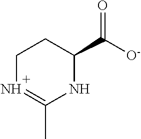

The structure of natural hydroxyectoine ((4S,5S)-5-hydroxy-2-methyl-1,4,5,6-tetrahydropyrimidine-4-carboxylic acid) is indicated hereunder:

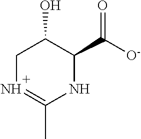

The use of the stereoisomers indicated is preferred but not obligatory, that is other stereoisomers or racemates may also be employed.

Especially preferred is the use of hydroxyectoine. Also preferred is the use of an HTK solution as base, i.e. a storage solution containing histidine, tryptophan and α-ketoglutarate or corresponding salts. Most preferably is the use of hydroxyectoine or a salt of hydroxyectoine in a storage solution containing histidine, tryptophan and α-ketoglutarate or corresponding salts.

The concentration of ectoine/hydroxyectoine should range between 0.1 and 100 mM. Preferred are concentrations ranging between 1 and 10 mM, particularly preferred between 4 and 7 mM, and most preferable are concentrations of approx. 5 mM. At suitable concentrations it was noticed that organ injuries/damage had reduced significantly.

A typical aqueous HTK solution contains:

| | | |
|---|---|---|
| Sodium chloride | 15.0 | mM |
| Potassium chloride | 9.0 | mM |
| Magnesium chloride hexahydrate | 4.0 | mM |
| Histidine hydrochloride monohydrate | 18.0 | mM |
| Histidine | 180.0 | mM |
| Tryptophan | 2.0 | mM |
| Mannitol | 30.0 | mM |
| Calcium chloride dihydrate | 0.015 | mM |
| Potassium hydrogen 2-ketoglutarate | 1.0 | mM |

The HTK solution principle is based on the inactivation of the organ function through the withdrawal of extracellular sodium and calcium, together with buffering of the extracellular environment by means of histidine/histidine hydrochloride. In this manner, the time span can be extended which the organs are capable of tolerating when the supply with oxygenated blood is interrupted. The electrolyte composition of the HTK solution inhibits the triggering of energy-consuming activation processes resulting in the energy consumption of the organ being reduced. The histidine/histidine hydrochloride buffer slows down the drop in pH during ischemia so that the efficiency of the anaerobic energy recovery improves. Potassium hydrogen 2-ketoglutarate serves as substrate for the aerobic energy recovery, tryptophan shall have a membrane-protective effect and mannitol is meant to prevent a cellular edema from developing. The properties of such a solution can be optimized by adding the amount of ectoine/hydroxyectoine indicated.

This also applies similarly when it is added to a UW solution also known under the tradename of Viaspan. The composition resembles that of the cytosol present inside the cells. The solution is based, inter alia, on the principle that metabolically inert substances such as lactobionic acid or relevant salts or raffinose maintain the osmotic concentration. Hydroxyethyl starch serves to prevent edema. Moreover, substances may be added that cause free radicals to be scavenged.

A typical aqueous UW solution contains:

| | | |
|---|---|---|
| Potassium lactobionate | 100 | mM |
| KH₂PO₄ | 25 | mM |
| MgSO₄ | 5 | mM |
| Raffinose | 30 | mM |
| Adenosine | 5 | mM |
| Glutathione | 3 | mM |
| Allopurinol | 1 | mM |
| Hydroxyethyl starch | 50 | g/l |

Lastly, the properties of a Celsior solution may be improved as well by the addition of ectoine/hydroxyectoine. The solution inter alia contains mannitol, lactobionic acid, glutamic acid, histidine, calcium chloride, potassium chloride, magnesium chloride, sodium hydroxide, and glutathione. A typical aqueous composition contains:

| | | |
|---|---|---|
| Mannitol | 60 | mM |
| Lactobionic acid | 80 | mM |
| Glutamic acid | 20 | mM |
| Histidine | 30 | mM |
| Calcium chloride | 0.25 | mM |
| Potassium chloride | 15 | mM |
| Magnesium chloride | 13 | mM |
| Sodium hydroxide | 100 | mM |
| Reduced glutathione | 3 | mM |

The invention is particularly useful for the transplantation of kidney, heart, lung, liver or pancreas. However, it may also be employed for the storage of tissue to be transplanted, for example of the cornea or organ systems such as fingers or hands.

The storage solution, especially when it is based on an HTK solution, may contain additional components known in the state of the art. In this context, special reference is made to European patents EP 1 362 511 B1 and 1 859 679 B1. Also forming explicitly part of this patent application is a storage solution according to claim 1 that moreover contains components of organ storage solutions described in the European patents mentioned.

In particular, the storage solution may contain hydroxamic acid or a hydroxamic acid derivative which, as the case may be, is alkyl- or aryl-substituted. Especially is suited is deferoxamine which is a strong iron chelator and possesses as many as three hydroxamic acid functions. In this way, iron-related cold-induced injuries are prevented. Basically, other iron chelators may be employed as well. A buffer may be used on the basis of N-Acyl histidine, in particular N-acetyl histidine as well as the relevant base.

Lysine, arginine or glycine or relevant derivatives may be contained, for example lysine-, arginine- or glycine-containing dipeptides. The same applies to the other natural amino acids alanine, valine, leucine, isoleucine, methionine, proline, phenylalanine, tryptophan, serine, threonine, asparagine, aspartic acid, glutamine, glutamic acid, tyrosine, cysteine, and histidine. The basic amino acids lysine and arginine or derivatives thereof may be used as base equivalents.

Also of advantage is the addition of aspartate that not only assists the exchange of substances across membranes but also accelerates the restoration of the homeostasis and, moreover, in conjunction with α-ketoglutarate favorably influences the aerobic energy metabolism during the reperfusion phase.

To meet the energy requirements of the organ during ischemia glucose can be added to the storage solution. The glucose concentration in this case must be suitably chosen such that an excessive uptake of glucose by other cells is prevented. Other sugars, sugar alcohols or other polyols (e.g. mannitol, raffinose, saccharose, xylitol, sorbitol) or high-molecular substances such as HES or dextran may be put to use to reach the required physiological osmotic pressure of approx. 300 mosm/l.

Dimethyl sulfoxide (DMSO) can be used as cryoprotectant. Radical scavengers such as Trolox (6-hydroxy-2,5,7,8-tetramethylchroman-2-carboxylic acid) may be employed to intercept intracellular radicals.

The storage solution proposed by the present invention may of course not only be used for the preservation of organs, tissue or organ systems, but also for perfusion purposes during the process of harvesting organs from the donors. Typically, the organ is perfused with the storage solution and subsequently preserved and transported in the storage solution until it is implanted into the body of the recipient.

### EXAMPLE

In the experiments carried out the liver of male Wistar rats was removed under the influence of ilsoflurane anesthesia. Three groups were formed for this purpose:

A control group (NaCl group): No warm or cold ischemia time (n=5)

Test group 1 (HTK group): The livers were flushed with 60 ml of HTK solution (n5) after a warm ischemia time of 30 min.

Test group 2 (HTK+hydroxyectoine group): After a warm ischemia time of 30 min. the livers were flushed with 60 ml of an HTK solution that had a hydroxyectoine concentration of 5.27 mM (n=5).

In the test groups, a cannula was laid to the portal vein 30 min. after cardiac arrest using a 14-gauge polyethylene tubing. Following this, the livers were flushed via the portal vein with 20 ml of an ice-cooled saline solution (0.9%, DeltaSelect GmbH, Dreieich, Germany). Afterwards, the livers were removed and immediately flushed at 4° C. with 60 ml of an HTK solution (Dr. Franz Köhler Chemie, Germany), respectively with 60 ml of HTK solution containing 5.27 mM of hydrogectoine.

At 4° C. and in an additional 60 ml of the respective organ storage solution the livers had then been preserved for 24 h. During storage, a short 14-gauge polyethylene catheter was inserted and secured in the suprahepatic vena cava.

In order to simulate warming taking place during reimplantation the organs were brought to room temperature within a period of 30 min. Prior to connection to the perfusion circuit the livers were flushed via the portal vein catheter with 10 ml of saline solution at 22° C. for a maximum period of 35 min. The perfusion circuit itself was also flushed with 200 ml of sterile saline solution and subsequently flushed through with 100 ml of Krebs-Henseleit buffer (KHB). Reperfusion had been carried out ex vivo for 45 min. in a recirculating system at a constant flow rate of 3 ml per gram of liver and minute using 220 ml of oxygenated KHB at 37° C. Carbogen (95% O₂, 5% CO₂) was used for oxygenation, with the partial pressure of oxygen in the perfusate being constantly kept at more than 500 mm Hg.

The control group (NaCl group) was neither exposed to warm nor to cold ischemia. Only during removal were the livers flushed with NaCl and HTK solution and reperfused immediately.

Results

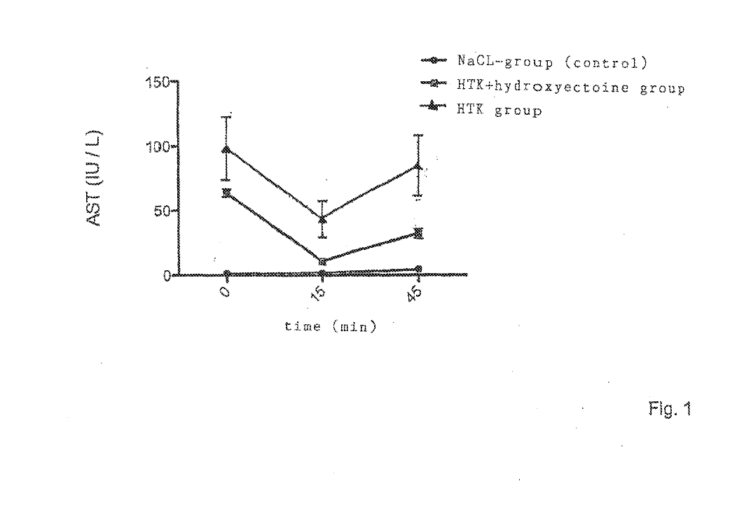

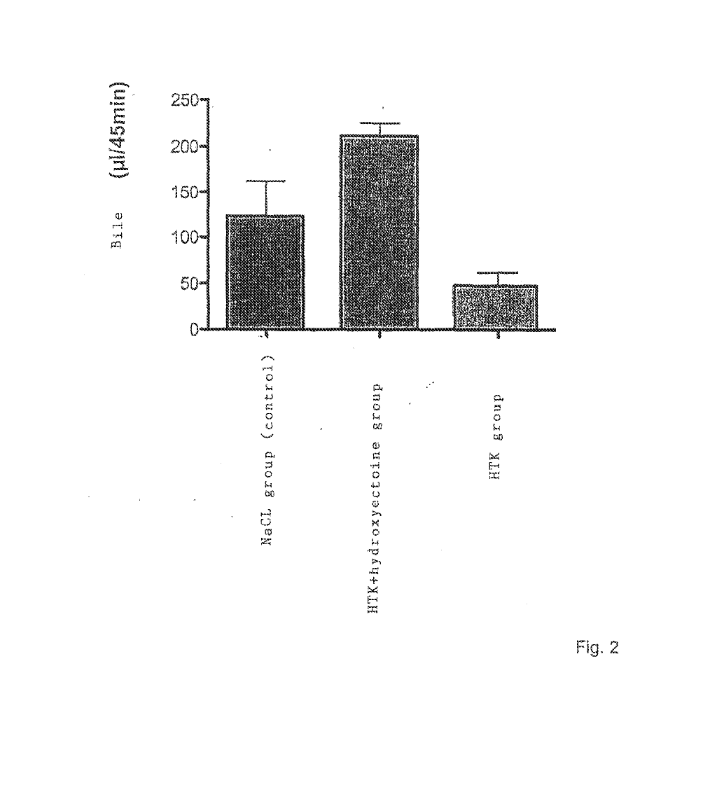

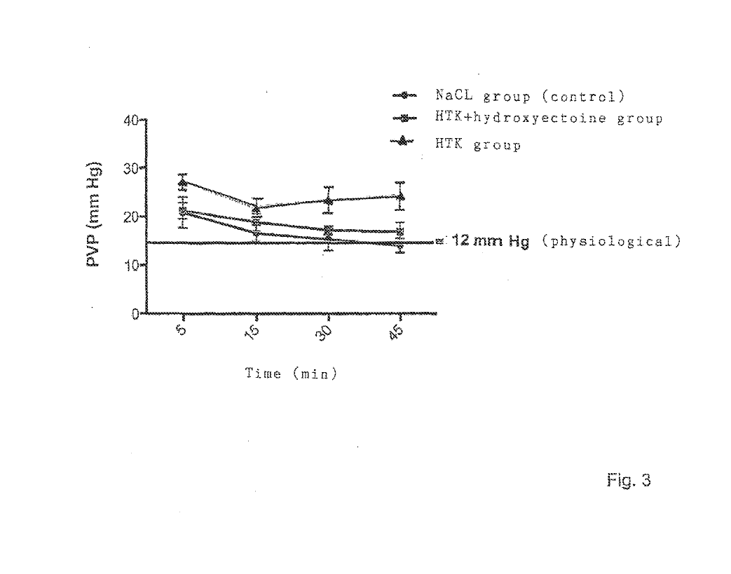

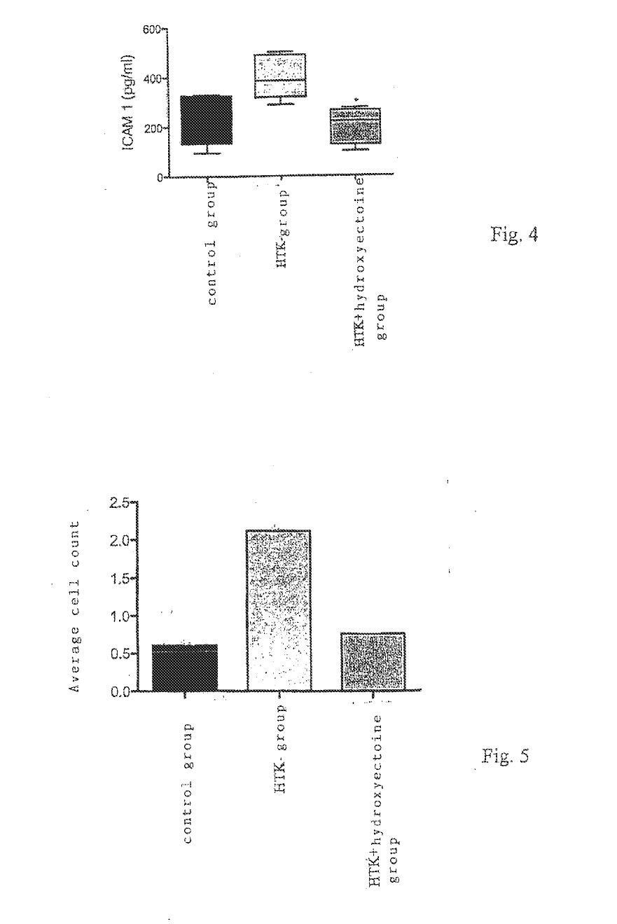

1) The enzyme aspartate aminotransferase (AST) converts aspartate and α-ketoglutarate to oxalacetate and glutamate or vice versa. A distinction is made between two forms of isoenzymes, AST-1 and AST-2. An elevated level in blood is normally associated with hepatic dysfunction so that they are used as biochemical markers warning of liver damage. The measurement was taken by means of customary photometric methods in a clinical analyzer (Vitros 250, Ortho-Clinical-Diagnostics, N.J., USA). The results are shown in FIG. 1. It can be seen that after a reperfusion time of 15 and 45 min. the AST level was significantly higher in the HTK group than in the HTK+hydroxyectoine groups.
2) Bile is a dark green or yellow-brown fluid produced by hepatocytes. Since there is no gall bladder in rats it flows directly through the bile duct. A catheter was inserted into the bile duct with a view to collecting the fluid during reperfusion. The amount of bile is directly related to the liver function, with larger amounts of bile being correlated with better organ functioning. The production of bile was significantly higher in the HTK+hydroxyectoine group than in the HTK group (refer to FIG. 2).
3) The portal venous pressure (PVP) is the pressure prevailing in the portal vein which is usually in the range of between 5 and 12 mm Hg. It is thus to be regarded as the resistance that must be overcome with a view to pumping blood through the blood circulation system. During reperfusion the portal venous pressure was continuously measured at the portal vein outflow catheter. As can be seen from FIG. 3 the portal venous pressure in the HTK+hydroxyectoine group was lower than in the HTK group.
4) ICAM-1 (the intercellular adhesion molecule 1) was determined to ascertain the inflammatory reaction of damaged sinusoidal endothelial cells. In comparison to the HTK group the control group showed significantly lower levels (242±46.22 pg/ml as compared to 403.6±39.61 pg/ml). Also the HTK+hydroxyectoine group showed significantly lower values (305.2±37.71) pg/ml versus the HTK group. The results are illustrated in FIG. 4 (*: P<0.05 versus the HTK group).
5) Apoptosis was made visible by adopting the TUNEL method (terminal deoxynucleotidyl transferase-mediated dUTP-biotin nick end labeling). This method enables the 3′—OH groups of the fragmented DNA strand developing during apoptosis to be provided with labeled nucleotides through transferase. A standard protocol and a commercially available kit (Boehringer Mannheim, Mannheim, Germany) were used with incubation using 3-aminoethyl carbazole and staining through hematoxylin. The result is illustrated in FIG. 5. In the control group only a minor amount of apoptotic cells was observed (0.6±0.3 average cell count), whereas this figure is significantly higher in the HTK group (2.12±0.13). In comparison with this the rate of apoptosis determined for the HTK+hydroxyectoine group is significantly lower (0.76±0.17).

All experiments were carried out in compliance with animal protection legislation in force in the Federal Republic of Germany. The principles laid down in the framework of Laboratory Animal Care (NIH, 1985) were applied.

Claims

1. Storage solution for the preservation of organs, tissue or organ systems to be transplanted, said storage solution containing
histidine, tryptophan, and α-ketoglutarate or corresponding salts or
lactobionic acid and/or raffinose as well as hydroxyethyl starch or corresponding salts or
mannitol, lactobionic acid, glutamic acid, histidine, calcium chloride, potassium chloride, magnesium chloride, sodium hydroxide, and glutathione or corresponding salts, characterized in that, the storage solution contains ectoine, hydroxyectoine and/or a salt, ester, or amide of ectoine or hydroxyectoine.

2. Storage solution according to claim 1, characterized in that the storage solution contains hydroxyectoine.

3. Storage solution according to claim 1, characterized in that the concentration of ectoine and/or hydroxyectoine ranges between 0.1 and 100 mM.

4. Storage solution according to claim 3, characterized in that the concentration of ectoine and/or hydroxyectoine ranges between 1 and 10 mM.

5. Storage solution according to claim 4, characterized in that the concentration of ectoine and/or hydroxyectoine ranges between 4 and 7 mM, and in particular amounts to approx. 5 mM.
